(19) United States
(12) Patent Application Publication
(10) Pub. No.: US 2026/0070441 A1
(43) Pub. Date: Mar. 12, 2026

(54) ON BOARD CHARGING MODULE WITH POWER FACTOR CORRECTION

(71) Applicant: GM GLOBAL TECHNOLOGY OPERATIONS LLC, Detroit, MI (US)

(72) Inventors: Minh-Khai NGUYEN, Troy, MI (US); Lei HAO, Troy, MI (US); Chandra S. NAMUDURI, Troy, MI (US); Renato Amorim TORRES, Pontiac, MI (US); Peng PENG, Rochester Hills, MI (US); Mohamed KAMEL, Birmingham, MI (US)

(21) Appl. No.: 18/830,362

(22) Filed: Sep. 10, 2024

(51) Int. Cl. B60L 53/22

(52) U.S. Cl. CPC B60L 53/22; B60L 2210/14; B60L 2210/30

(57) ABSTRACT

An on board charger for a vehicle including an electric machine and a battery system includes a power inverter and a DC-DC converter. A filter including first and second inputs is selectively connected to an AC source and first and second outputs. The first output of the filter is connected to one of the first node, the second node, and the third node between switches of phase legs of the power inverter. A switching device includes a first terminal connected to the one of the first node, the second node, and the third node, a second terminal connected to a second output of the filter, and a third terminal connected to one of the first, second, and third phase windings of the electric machine corresponding the one of the first node, the second node, and the third node.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to charging systems, and more particularly to an on board charging module with power factor correction for a vehicle including a battery system and an electric machine.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

An onboard charging module (OBCM) is a device located on board electric vehicles (EVs) that converts alternating current (AC) power from an AC source (e.g., a utility) for charging the battery system. For example, the OBCM allows the vehicle to be charged using power outlets at home. The OBCM determines the maximum charge rate while an AC source is connected to the vehicle and helps to manage the flow of power from the AC source to the battery pack.

### SUMMARY

An on board charger for a vehicle including an electric machine and a battery system includes a power inverter including first, second and third phase legs each including first and second switches connected between first and second conductors. First, second, and third nodes are located between the first and second switches in the first, second, and third phase legs, respectively. The first, second, and third nodes are connected to first, second, and third phase windings of the electric machine, respectively, when supplying power from the battery system to the electric machine during operation. A direct current (DC)-DC converter includes a first portion connected between the first and second conductors and a second portion connected between third and fourth conductors. A filter including first and second inputs is selectively connected to an alternating current (AC) source and first and second outputs. The first output of the filter is connected to one of the first node, the second node, and the third node. A switching device includes a first terminal connected to the one of the first node, the second node, and the third node, a second terminal connected to a second output of the filter, and a third terminal connected to one of the first, second, and third phase windings of the electric machine corresponding the one of the first node, the second node, and the third node.

In other features, the first portion of the DC-DC converter includes first and second legs each including third and fourth switches. The DC-DC converter includes a first inductor including a first terminal connected between the third and fourth switches in the first leg, a first capacitor including a first terminal connected between the third and fourth switches in the second leg, a transformer including first and second terminals connected to second terminals of the first inductor and the first capacitor, a second inductor including a first terminal connected to a third terminal of the transformer, and a second capacitor including a first terminal connected to a fourth terminal of the transformer.

In other features, the second portion of the DC-DC converter includes third and fourth switches connected between the third and fourth conductors and fifth and sixth switches connected between the third and fourth conductors. A node between the third and fourth switches is connected to a second terminal of the second inductor. A node between the third and fourth switches is connected to a second terminal of the second capacitor.

In other features, third and fourth switches selectively connect the AC source to the filter. A voltage sensor is configured to sense a voltage of the AC source. A controller is configured close the third and fourth switches to initiate AC charging when the voltage has a zero crossing.

In other features, a controller is configured to control the power inverter and the DC-DC converter during AC charging from the AC source. The controller is configured to control the power inverter and the DC-DC converter to provide power factor correction during the AC charging from the AC source.

In other features, a first capacitor is connected between the first and second conductors at an input of the power inverter. A second capacitor is connected between the first and second conductors at an input of the DC-DC converter.

In other features, a third switch is configured to selectively connect the first conductor to the battery system through a first resistor. A fourth switch is configured to selectively connect the second conductor to the battery system. The controller is configured to control the third switch and the fourth switch to pre-charge the first capacitor and the second capacitor prior to the AC charging.

An on board charger for a vehicle including an electric machine and a battery system includes a power inverter including first, second and third phase legs each including first and second switches connected between first and second conductors. First, second, and third nodes are located between the first and second switches in the first, second, and third phase legs, respectively. The first, second, and third nodes are connected to first, second, and third phase windings of the electric machine, respectively, when supplying power from the battery system to the electric machine during operation. A DC-DC converter includes a first portion connected between the first and second conductors and a second portion connected between third and fourth conductors. A filter including first and second inputs is selectively connected to an AC source and first and second outputs. A phase leg includes third and fourth switches connected between the first and second conductors. The first output of the filter is connected to one of the first node, the second node, and the third node. The second output of the filter is connected to a node between the third and fourth switches of the phase leg.

In other features, the first portion of the DC-DC converter includes first and second legs each including third and fourth switches. The DC-DC converter includes a first inductor including a first terminal connected between the third and fourth switches in the first leg, a first capacitor including a first terminal connected between the third and fourth switches in the second leg, a transformer including first and second terminals connected to second terminals of the first inductor and the first capacitor, a second inductor including a first terminal connected to a third terminal of the transformer, and a second capacitor including a first terminal connected to a fourth terminal of the transformer.

In other features, the second portion of the DC-DC converter includes third and fourth switches connected between the third and fourth conductors and fifth and sixth switches connected between the third and fourth conductors. A node between the third and fourth switches is connected to a second terminal of the second inductor. A node between the third and fourth switches is connected to a second terminal of the second capacitor.

In other features, third and fourth switches selectively connect the AC source to the filter. A voltage sensor is configured to sense a voltage of the AC source. A controller is configured close the third and fourth switches to initiate AC charging when the voltage has a zero crossing.

In other features, a controller is configured to control the power inverter and the DC-DC converter during AC charging from the AC source. The controller is configured to control the power inverter and the DC-DC converter to provide power factor correction during the AC charging from the AC source.

In other features, a first capacitor is connected between the first and second conductors at an input of the power inverter. A second capacitor is connected between the first and second conductors at an input of the DC-DC converter.

In other features, a third switch is configured to selectively connect the first conductor to the battery system through a first resistor. A fourth switch is configured to selectively connect the second conductor to the battery system. The controller is configured to control the third switch and the fourth switch to pre-charge the first capacitor and the second capacitor prior to the AC charging.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram and electrical schematic of an example of an on board charging module including an alternating current (AC)-direct current (DC) converter with power factor control and a full bridge isolated DC-DC converter;

FIG. 2 is a functional block diagram and electrical schematic of an example of another on board charging module;

FIG. 3 is a functional block diagram and electrical schematic of an example of an on board charging module according to the present disclosure; and

FIG. 4 is a functional block diagram and electrical schematic of an example of another on board charging module according to the present disclosure.

In the drawings, reference numbers may be reused to identify similar and/or identical elements.

### DETAILED DESCRIPTION

While the present disclosure relates to an on board charging module for a vehicle including a battery pack, the on board charging module can be used for other applications.

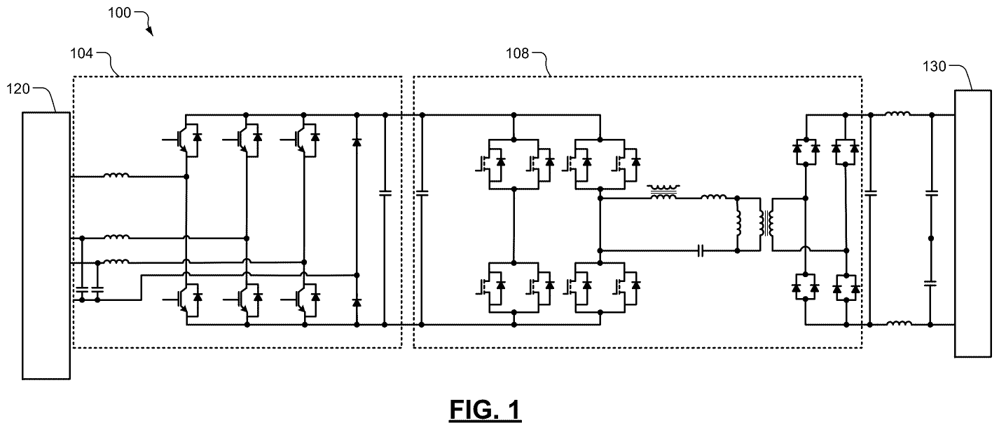

Referring now to FIG. 1, an on board charging module (OBCM) (or on board charger) 100 includes an alternating current (AC)-direct current (DC) converter 104 with power factor correction (PFC) and a full-bridge isolated DC-DC converter 108. An AC source 120 (e.g., a 3-phase (shown) or single phase (not shown)) is connected to an input of the AC-DC converter 104. If the single phase AC source is used, the inputs of the AC-DC converter 104 can be shorted.

A DC output of the full-bridge isolated DC-DC converter 108 is coupled to a battery system 130. The AC-DC converter 104 with PFC corresponds to approximately 30% of the cost and size of the OBCM 100. As can be appreciated, some of the components of the on board charging module (OBCM) 100 are duplicated in a power inverter and electric machine used in a battery control system of the vehicle.

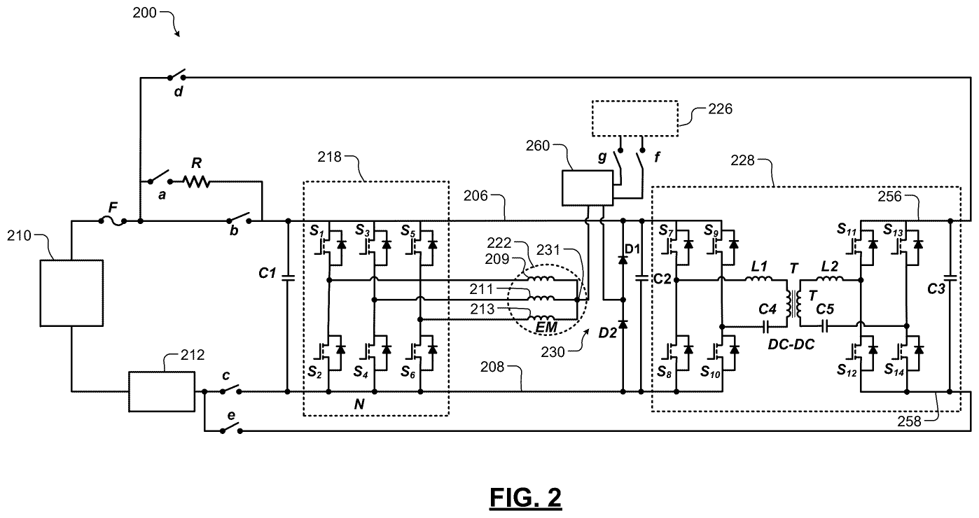

Referring now to FIG. 2, rather than using a separate AC-DC converter with PFC in the OBCM as in FIG. 1, operation of a power inverter in a battery charging system and the electric machine are adjusted to eliminate components and reduce the cost and packing size of the charging system. During use of the OBCM, the power inverter of the battery charging system and the electric machine are not being used since they are not supporting propulsion or regeneration functions.

For example, an on board charging module (OBCM) 200 for a battery system 210 uses a power inverter 218 and the electric machine (that are used for propulsion and/or regeneration) to perform PFC (eliminating the need for a separate AC-DC converter with PFC). The power inverter 218 includes 3 phase legs. A first phase leg includes switches S1 and S2 that are connected in series between first and second conductors 206 and 208. A node between the switches S1 and S2 of the first phase leg is connected to a first phase winding 209 of the EM.

A second phase leg includes switches S3 and S4 connected in series between the first conductor 206 and the second conductor 208. A node between the switches S3 and S4 of the second phase leg is connected to a second phase winding 211 of the EM. A third phase leg includes switches S5 and S6 connected in series between the first conductor 206 and the second conductor 208. A node between the switches S5 and S6 of the third phase leg is connected to a third phase winding 213 of the EM.

Second ends of the first, second and third phase windings 209, 211, and 213, respectively, of the EM are connected together. The second ends of the first, second and third phase windings 209, 211, and 213, respectively, are connected to a first input of a filter 260. In some examples, the filter 260 includes an electromagnetic compatibility (EMC) filter that attenuates radio frequencies (RFI) and/or electromagnetic interference (EMI). A first terminal of a switch g selectively connects a first input of the filter 260 to an AC source 226 (e.g., providing single phase AC power).

A first capacitor C1 is connected across the first conductor 206 and the second conductor 208 (at an input of the power inverter 218). In some examples, switches a and c are closed during pre-charging of the first capacitor C1 and a second capacitor C2 (at an input of a DC-DC converter 228). The first capacitor C1 and the second capacitor C2 are pre-charged prior to AC charging or operation of the battery system in propulsion and/or regeneration modes.

Switches b and c include first terminals connected to the first conductor 206 and the second conductor 208, respectively. The switches b and c are closed when supplying power from the battery system to the EM. A second terminal of the switch b is connected to a first terminal of a fuse F. A second terminal of the fuse F is connected to a first terminal of the battery system 210. A first terminal of a resistor R is connected to the first conductor 206. A second terminal of the resistor R is connected to a first terminal of the switch a. A second terminal of the switch a is connected to the first terminal of the fuse F. A second terminal of the switch c is connected to a first terminal of a pyro switch 212. A second terminal of the pyro switch 212 is connected to a second terminal of the battery system 210.

The first conductor 206 is connected to a cathode of a diode D1 of a half-bridge rectifier 230. An anode of the diode D1 is connected to a cathode of a diode D2 of the half-bridge rectifier 230 and to a first terminal of a switch f (through the filter 260). An anode of the diode D2 is connected to the second conductor 208.

The capacitor C2 is connected between the first conductor 206 and the second conductor 208. The DC-DC converter 228 includes pairs of switches including S7 and S8 and S9 and S10 that are connected between the first conductor 206 and the second conductor 208. An inductor L1 includes a first terminal connected to a node between the switches S7 and S8. A second terminal of the inductor L1 is connected to a first terminal of a transformer T. A node between the switches S9 and S10 is connected to one terminal of a capacitor C4. A second terminal of the capacitor C4 is connected to a second terminal of the transformer T. A third terminal of the transformer is connected to a first terminal of an inductor L2.

The DC-DC converter 228 includes pairs of switches S11 and S12 and S13 and S14 that are connected between first and second conductors 256 and 258, respectively. A second terminal of the inductor L2 is connected between the switches S11 and S12. A fourth terminal of the transformer T is connected to a first terminal of a capacitor C5. A second terminal of the capacitor C5 is connected between the switches S13 and S14. A capacitor C3 is connected between the first and second conductors 256 and 258.

First terminals of optional switches d and e are connected to the first and second conductors 256 and 258, respectively. A second terminal of the switch d is connected to the first terminal of the fuse F. A second terminal of the switch e is connected to the first terminal of the pyro switch 212. Second terminals of the switches g and f are connected to the AC source 226. In some examples, switches d and e are on to connect the output of the DC-DC converter to the battery system.

During startup of the battery system for propulsion and/or AC charging use, the switches a and c are closed to pre-charge the capacitors C1 and C2 and the switches b, c, d, and e are open. After pre-charging the capacitors C1 and C2, power can be supplied from the battery system 210 to the electric machine (EM) or from the EM to the battery system 210 during regeneration. When supplying power from the battery system 210 to the EM, the switches b and c are closed and the switches a, d, and e are open. When supplying power from the EM to the battery system 210, the switches d and e are closed and the switches a, b, and c are open.

The power inverter 218 for the EM performs power factor correction. A first terminal of the AC source 226 is connected by the filter 260 to a neutral node 231 of the EM. A second terminal of the AC source 226 is connected by the filter 260 to a node between the diodes D1 and D2 of the half-bridge rectifier 230. The power inverter 218 acts as a 3-phase interleaved boost PFC circuit using inductances of windings of the EM. As can be appreciated, the switches a to f can be relays.

However, the EMs may not provide access to the second terminals of the electric machine (either individually or connected together). Therefore, this approach may not be possible for some electric machines.

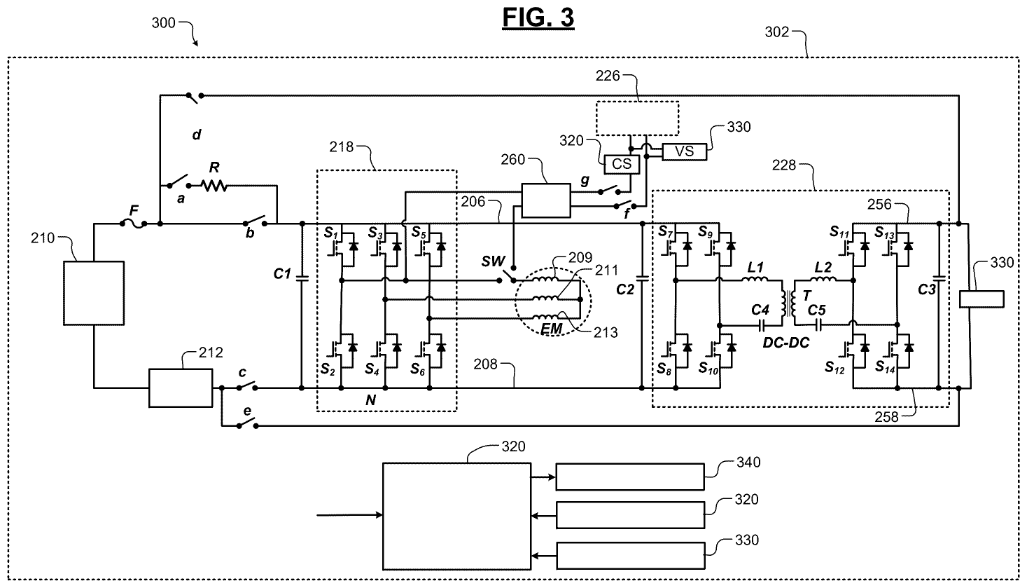

Referring now to FIG. 3, an OBCM 300 for a vehicle 302 is shown. The AC source 226 is connected to the power inverter 218 in a different manner than in FIG. 2. A first output of the filter 260 is connected to the node between the switches S1 and S2 of the power inverter 218. A second output of the filter 260 is connected to a first terminal of a switch SW (e.g., a single pull, double throw (SPDT) relay or two relays). In some examples, the SW is integrated within the power inverter 218. In other examples, the SW is external to the power inverter 218 or arranged in the OBCM.

A second terminal of the switch SW is connected between the switches S1 and S2 of the power inverter 218. A third terminal of the switch SW is connected to one of the phase windings of the EM (e.g., the same phase winding connected to the switches S1 and S2).

During charging, terminals of the AC source 226 are connected to the phase terminal (e.g., to the node between one of the phase legs such as the switches S1 and S2) and an opened terminal or phase winding of the EM. The direct axis (d-axis) of the electric machine is aligned to the corresponding phase winding prior to opening the EM terminal using the SW. The d axis is the axis by which flux is produced by the field winding. When the EM comprises a permanent magnet EM, motor position is aligned such that the d-axis of the rotor is aligned with the phase to which the AC charge port is connected during OBCM function to prevent movement of the EM. Switches S1 and S2 connected to the AC source 226 are kept off and antiparallel diodes of the switches S1 and S2 are used during interleaved PWM control of the remaining two phase legs.

In some examples, a controller 320 is connected to the switches of the OBCM 300 and one or more sensors that sense operating parameters such as voltage and current of the OBCM. In some examples, a voltage sensor 330 and a current sensor 320 sense voltage and current supplied by the AC source. A voltage sensor 330 senses an output voltage of the DC-DC converter 228.

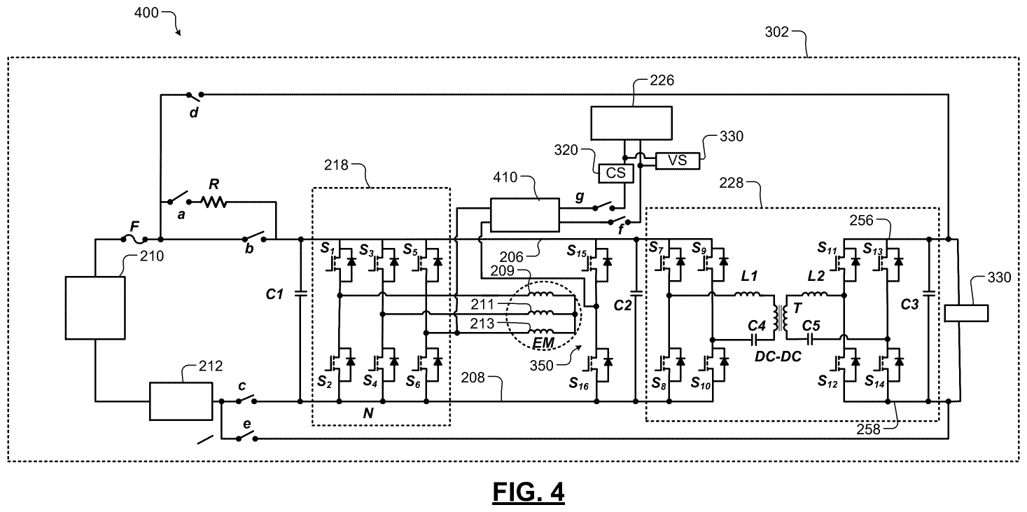

Referring now to FIG. 4, an OBCM 400 is shown. The AC source 226 is connected to the power inverter 218 in a different manner than in FIGS. 2 or 3. First terminals of the switches g and f are connected to outputs of the filter 260. Switches S15 and S16 of another phase leg 350 are connected in series between the first conductor 206 and the second conductor 208.

During AC charging, a first input of the filter 260 is connected to one of the phase windings of the EM. A second input of the filter 260 is connected between the switches S15 and S16 of the phase leg 350. Machine rotor d-axis is aligned to the phase winding prior to charging to avoid movement of the EM during charging.

The OBCM according to the present disclosure provides the power factor correction (PFC) function of an OBCM using an existing propulsion inverter and EM without requiring a neutral point access of EM and DC bus. During PFC control, input voltage and current supplied to the battery system have aligned phases.

The AC charge port input is selectively connected between a phase winding terminal and a half-bridge leg of the power inverter. The remaining phase legs of the power inverter and phase windings of the EM are used as 2-phase interleaved boost power factor stage of the OBCM. An isolated DC-DC converter part of the existing OBCM is used for regulating the charging current and voltage at the battery.

The OBCM with PFC according to the present disclosure leverages the EM without a neutral connection and an inverter without DC bus mid-point access to charge the battery from an AC source. In some examples, the SW (or SPDT relay or relays) selectively connects the AC charge port between a terminal of the phase winding and a terminal of the power inverter. The SPDT switch can be integrated within the power inverter, external to the power inverter, or inside the OBCM. In other examples, the AC source is selectively connected between a phase winding terminal and a switching node of a half-bridge leg in the input stage of the OBCM or integrated inside the power inverter.

The OBCM with PFC eliminates some or all of the components of the active front-end stage of the OBCM, which reduces cost and size. In some examples, a DC-link film capacitor of the power inverter is reused to minimize or eliminate the electrolytic capacitors from the OBCM.

In some examples, prior to AC charging, the switches a and c are closed (e.g., conducting) to pre-charge the capacitors C1 and C2. After a pre-charging period, the switches a and c are opened. In FIG. 3, the SW (the SPDT relay or relays) is positioned to connect the phase winding of the EM to the filter 260. In FIG. 4, the switches S15 and S16 are closed. Then, the switches g and f are closed for AC charging. The controller 360 controls the switches in the power inverter 218 and the DC-DC converter 228 to charge the battery system 210 and control PFC by aligning current and voltage phases.

In some examples, prior to AC charging, the switches a and c are closed (e.g., conducting) to pre-charge the capacitors C1 and C2. After a pre-charging period, the switches a and c are opened. In FIG. 3, the SW (the SPDT relay or relays) is positioned to connect the phase winding of the EM to the filter. In FIG. 4, the switches S15 and S16 are closed. The controller 320 monitors the AC input voltage. The switches g and f are closed for AC charging when the AC input voltage is at the zero crossing to eliminate inrush current. The controller 360 controls the switches in the power inverter 218 and the DC-DC converter 228 to charge the battery system 210 and control PFC by aligning current and voltage phases.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. An on board charger for a vehicle including an electric machine and a battery system, comprising:
a power inverter including:
first, second and third phase legs each including first and second switches connected between first and second conductors;
first, second, and third nodes located between the first and second switches in the first, second, and third phase legs, respectively,
wherein the first, second, and third nodes are connected to first, second, and third phase windings of the electric machine, respectively, when supplying power from the battery system to the electric machine during operation;
a direct current (DC)-DC converter including a first portion connected between the first and second conductors and a second portion connected between third and fourth conductors;
a filter including first and second inputs selectively connected to an alternating current (AC) source and first and second outputs,
wherein the first output of the filter is connected to one of the first node, the second node, and the third node; and
a switching device including a first terminal connected to the one of the first node, the second node, and the third node, a second terminal connected to a second output of the filter, and a third terminal connected to one of the first, second, and third phase windings of the electric machine corresponding the one of the first node, the second node, and the third node.

2. The on board charger of claim 1, wherein the first portion of the DC-DC converter includes first and second legs each including third and fourth switches.

3. The on board charger of claim 2, wherein the DC-DC converter includes:
a first inductor including a first terminal connected between the third and fourth switches in the first leg;
a first capacitor including a first terminal connected between the third and fourth switches in the second leg;
a transformer including first and second terminals connected to second terminals of the first inductor and the first capacitor;
a second inductor including a first terminal connected to a third terminal of the transformer; and
a second capacitor including a first terminal connected to a fourth terminal of the transformer.

4. The on board charger of claim 3, wherein the second portion of the DC-DC converter includes:
third and fourth switches connected between the third and fourth conductors; and
fifth and sixth switches connected between the third and fourth conductors,
wherein a node between the third and fourth switches is connected to a second terminal of the second inductor, and
wherein a node between the third and fourth switches is connected to a second terminal of the second capacitor.

5. The on board charger of claim 4, further comprising:
third and fourth switches selectively connecting the AC source to the filter;
a voltage sensor configured to sense a voltage of the AC source; and
a controller configured close the third and fourth switches to initiate AC charging when the voltage has a zero crossing.

6. The on board charger of claim 1, further comprising a controller configured to control the power inverter and the DC-DC converter during AC charging from the AC source.

7. The on board charger of claim 6, wherein the controller is configured to control the power inverter and the DC-DC converter to provide power factor correction during the AC charging from the AC source.

8. The on board charger of claim 5, further comprising:
a first capacitor connected between the first and second conductors at an input of the power inverter; and
a second capacitor connected between the first and second conductors at an input of the DC-DC converter.

9. The on board charger of claim 8, further comprising:
a first resistor;
a third switch configured to selectively connect the first conductor to the battery system through the first resistor; and
a fourth switch configured to selectively connect the second conductor to the battery system.

10. The on board charger of claim 9, wherein the controller is configured to control the third switch and the fourth switch to pre-charge the first capacitor and the second capacitor prior to the AC charging.

11. An on board charger for a vehicle including an electric machine and a battery system, comprising:
a power inverter including:
first, second and third phase legs each including first and second switches connected between first and second conductors;
first, second, and third nodes located between the first and second switches in the first, second, and third phase legs, respectively,
wherein the first, second, and third nodes are connected to first, second, and third phase windings of the electric machine, respectively, when supplying power from the battery system to the electric machine during operation;
a direct current (DC)-DC converter including a first portion connected between the first and second conductors and a second portion connected between third and fourth conductors;
a filter including first and second inputs selectively connected to an alternating current (AC) source and first and second outputs; and
a phase leg including third and fourth switches connected between the first and second conductors,
wherein the first output of the filter is connected to one of the first node, the second node, and the third node, and
wherein the second output of the filter is connected to a node between the third and fourth switches of the phase leg.

12. The on board charger of claim 11, wherein the first portion of the DC-DC converter includes first and second legs each including third and fourth switches.

13. The on board charger of claim 12, wherein the DC-DC converter includes:
a first inductor including a first terminal connected between the third and fourth switches in the first leg;
a first capacitor including a first terminal connected between the third and fourth switches in the second leg;
a transformer including first and second terminals connected to second terminals of the first inductor and the first capacitor;
a second inductor including a first terminal connected to a third terminal of the transformer; and
a second capacitor including a first terminal connected to a fourth terminal of the transformer.

14. The on board charger of claim 13, wherein the second portion of the DC-DC converter includes:
third and fourth switches connected between the third and fourth conductors; and
fifth and sixth switches connected between the third and fourth conductors,
wherein a node between the third and fourth switches is connected to a second terminal of the second inductor, and
wherein a node between the third and fourth switches is connected to a second terminal of the second capacitor.

15. The on board charger of claim 14, further comprising:
third and fourth switches selectively connecting the AC source to the filter;
a voltage sensor configured to sense a voltage of the AC source; and
a controller configured close the third and fourth switches to initiate AC charging when the voltage has a zero crossing.

16. The on board charger of claim 11, further comprising a controller configured to control the power inverter and the DC-DC converter during AC charging from the AC source.

17. The on board charger of claim 16, wherein the controller is configured to control the power inverter and the DC-DC converter to provide power factor correction during the AC charging from the AC source.

18. The on board charger of claim 16, further comprising:
a first capacitor connected between the first and second conductors at an input of the power inverter; and
a second capacitor connected between the first and second conductors at an input of the DC-DC converter.

19. The on board charger of claim 18, further comprising:
a first resistor;
a third switch configured to selectively connect the first conductor to the battery system through the first resistor; and
a fourth switch configured to selectively connect the second conductor to the battery system.

20. The on board charger of claim 19, wherein the controller is configured to control the third switch and the fourth switch to pre-charge the first capacitor and the second capacitor prior to the AC charging.
